(19) United States
(12) Patent Application Publication
(10) Pub. No.: US 2015/0154176 A1
(43) Pub. Date: Jun. 4, 2015

(54) HANDWRITING INPUT SUPPORT APPARATUS AND METHOD

(71) Applicant: Kabushiki Kaisha Toshiba, Tokyo (JP)

(72) Inventors: Tsuyoshi Tasaki, Yokohama Kanagawa (JP); Yuto Yamaji, Fuchu Tokyo (JP); Daisuke Hirakawa, Saitama Saitama (JP); Kazunori Imoto, Kawasaki Kanagawa (JP); Yojiro Tonouchi, Inagi Tokyo (JP); Yasunobu Yamauchi, Yokohama Kanagawa (JP)

(21) Appl. No.: 14/616,615

(22) Filed: Feb. 6, 2015

Related U.S. Application Data
(63) Continuation of application No. PCT/JP2013/076457, filed on Sep. 24, 2013.

(30) Foreign Application Priority Data
Sep. 25, 2012 (JP) 2012-210873

(51) Int. Cl. G06F 17/27; G06K 9/00

(52) U.S. Cl. CPC G06F 17/276; G06K 9/00436

(57) ABSTRACT

According to one embodiment, a handwriting input support apparatus includes the following units. The stroke input unit inputs first strokes, one stroke set of which corresponds to one character or one symbol. The stroke storage unit stores second strokes, the one stroke set of which corresponds to the one character or one symbol. The stroke prediction unit predicts third strokes, the one stroke set of which corresponds to the one character or one symbol, by searching for the second strokes using the first strokes. The prediction result display unit displays the third strokes. The settled result display unit settles fourth strokes by an instruction given to the stroke set of the third stroke, and displays the fourth strokes together with the first strokes.

### CROSS-REFERENCE TO RELATED APPLICATIONS

This application is a Continuation Application of PCT Application No. PCT/JP2013/076457, filed Sep. 24, 2013 and based upon and claiming the benefit of priority from Japanese Patent Application No. 2012-210873, filed Sep. 25, 2012, the entire contents of all of which are incorporated herein by reference.

### FIELD

Embodiments described herein relate generally to a handwriting input support apparatus, method, and program.

### BACKGROUND

In order to reduce a handwriting input load, a technique for predicting an input handwritten character string has been proposed.

### BRIEF DESCRIPTION OF THE DRAWINGS

FIG. 1 is a block diagram showing a handwriting input support apparatus according to the first embodiment;

FIG. 2 is a flowchart showing an example of handwriting input prediction processing according to the first embodiment;

FIG. 3 is a view showing a binary image of a stroke set;

FIG. 4 is a view showing a display example of an input prediction candidate list during handwriting input;

FIG. 5 is a view showing a settlement example of a prediction candidate by stroke set units;

FIG. 6 is a block diagram showing a handwriting input support apparatus according to the second embodiment;

FIG. 7 is a flowchart showing an example of handwriting input prediction processing according to the second embodiment;

FIG. 8 is a view showing a prediction database preparation stage and prediction stage;

FIG. 9 is a block diagram showing a handwriting input support apparatus according to the third embodiment;

FIG. 10 is a flowchart showing an example of handwriting input prediction processing according to the third embodiment;

FIG. 11 is a block diagram showing the hardware arrangement which implements a handwriting input support apparatus; and

FIG. 12 is a view showing a configuration example of a handwriting input support apparatus using a network.

### DETAILED DESCRIPTION

In general, according to one embodiment, a handwriting input support apparatus includes a stroke input unit, a stroke storage unit, a stroke prediction unit, a prediction result display unit, and a settled result display unit. The stroke input unit inputs first strokes, one stroke set of which corresponds to one character or one symbol. The stroke storage unit stores second strokes, the one stroke set of which corresponds to the one character or one symbol. The stroke prediction unit predicts third strokes, the one stroke set of which corresponds to the one character or one symbol, by searching for the second strokes using the first strokes. The prediction result display unit displays the third strokes. The settled result display unit settles fourth strokes by an instruction given to the stroke set of the third stroke, and displays the fourth strokes together with the first strokes.

Embodiments will be described hereinafter with reference to the drawings.

A handwriting input support apparatus according to this embodiment is applied to, for example, a notebook application including a pen input interface. This application allows the user to input notebook contents by handwriting. This embodiment relates to handwriting input support including handwriting input prediction. The user can select desired strokes (which may include text font) from one or a plurality of input prediction candidates which are presented during handwriting input. Strokes settled by this selection are inserted at a handwriting input position, and are treated as those which are actually input by the user by handwriting.

### First Embodiment

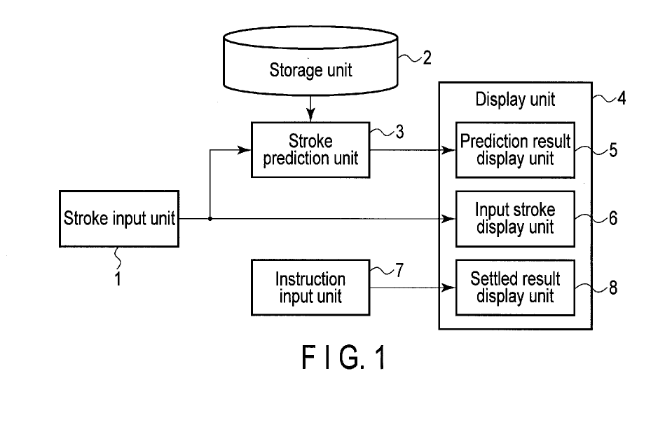

FIG. 1 is a block diagram showing a handwriting input support apparatus according to the first embodiment. This apparatus includes a stroke input unit 1, storage unit 2, stroke prediction unit 3, display unit 4, and instruction input unit 7. The display unit 4 includes a prediction result display unit 5, input stroke display unit 6, and settled result display unit 8.

The stroke input unit 1 inputs stroke data via the pen input interface. For example, the stroke input unit 1 associates, for example, a period from when a pen is brought into contact with a touch panel until it is released with one stroke data. The stroke data includes a stroke number required to identify a stroke, and time-series coordinates of a plurality of points in a locus generated by moving the pen which is in contact with the touch panel. The stroke number is incremented in a generation order of stroke data. Input stroke data are combined into a set for a unit of one character or symbol. This set will be referred to as a “stroke set” hereinafter. The stroke set is given with a set number required to identify this set. The set number is incremented in a generation order of stroke sets.

More specifically, a stroke set is generated as follows.

For example, one stroke set includes stroke data k and k−1 which satisfy a condition that a distance between start point coordinates of the stroke data k and end point coordinates of the stroke data k−1 is not more than a threshold. Alternatively, an input frame required to assist a handwriting input is displayed. One stroke set includes one or a plurality of stroke data input to one input frame. Alternatively, one stroke set includes one or a plurality of stroke data which are segmented for a unit of one character or symbol using a character recognition technique.

Therefore, strokes (first strokes) input by the stroke input unit 1 include one or a plurality of stroke sets in which one character or symbol corresponds to one stroke set, and are stored in the storage unit 2.

The storage unit 2 stores previously input strokes (second strokes). The second strokes have the same data structure as the first strokes, and are used to extract prediction candidates. The second strokes include strokes (third strokes) used as prediction candidates for input first strokes.

The stroke prediction unit 3 searches second strokes in the storage unit 2 using first strokes for one or a plurality of prediction candidates (third strokes). In the first embodiment, prediction candidates are obtained using similarity determination based on feature amounts of stroke images. In the second and third embodiments, prediction candidates are obtained based on character recognition results of stroke sets.

The prediction result display unit 5 displays a list of third strokes as prediction candidates during handwriting input. At the time handwriting input, a first stroke input by the stroke input unit 1 is displayed on the input stroke display unit 6, and third strokes are displayed as a list in the vicinity of the first stroke. The settled result display unit 8 settles fourth strokes by an instruction to a stroke set of third strokes, which is given via the instruction input unit 7, and displays the settled fourth strokes together with the first strokes.

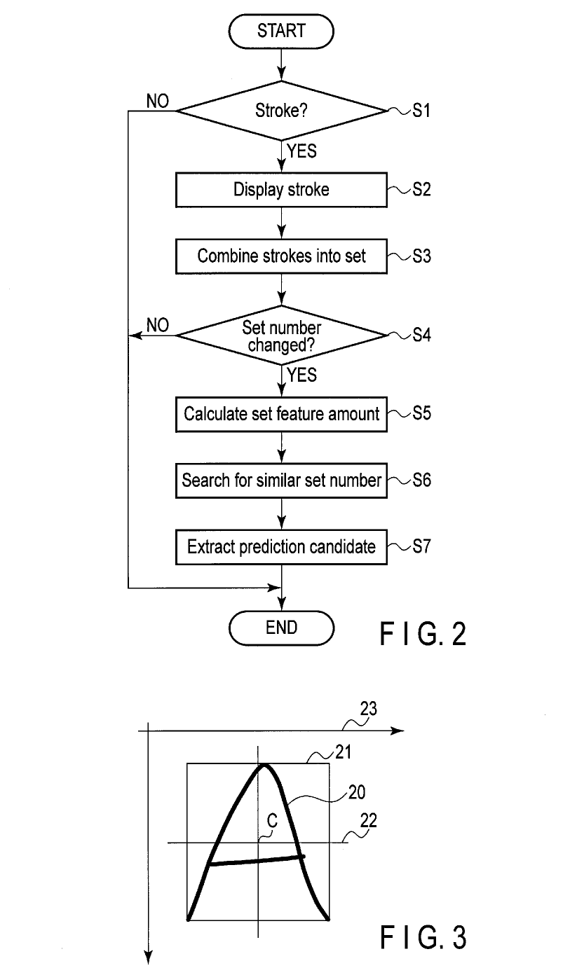

FIG. 2 is a flowchart showing an example of the handwriting input prediction processing according to the first embodiment. In this processing, a prediction candidate is obtained using similarity determination based on feature amounts of stroke images.

When the user inputs a stroke by operating the pen on the touch panel (step S1), that stroke is displayed on the touch panel by the input stroke display unit 6 (step S2). As described above, input strokes are combined into a set (step S3). Thus, a new set number is added, and prediction processing in steps S5 to S7 is executed via step S4.

In step S5, the stroke prediction unit 3 calculates image feature amounts of a stroke set of first strokes. In the first embodiment, a stroke set is handled as an image, as shown in FIG. 3. In a circumscribed rectangle 21 which bounds a stroke set 20, coordinates of a global coordinate system 23 of stroke data 20 are converted into those on a local coordinate system 22 having a rectangle center C as an origin. The stroke set 20 can be expressed as a binary image in which pixels indicated by this local coordinate system are, for example, black pixels, and those in the remaining region are white pixels. Image feature amounts can be calculated by computing Fourier transforms of the binary image of the stroke set 20. As such image feature amounts, an edge-based HOG (Histogram of Oriented Gradient) and the like may be used in addition to those based on the Fourier transforms.

In step S6, the storage unit 2 is searched based on the image feature amounts for a stroke set (set number) of second strokes similar to that of first strokes. Assume that second strokes are prediction candidate extraction targets, and image feature amounts of that stroke set have already been calculated and stored in the storage unit 2. More specifically, a database which associates set numbers, image feature amounts of stroke sets, and stroke data in association with each other is assured.

Similar stroke sets can be determined by checking, for example, when a Euclidean distance between image feature amounts is not more than a threshold. Note that similarity determination is not limited to use of static features such as Fourier transforms. For example, a dynamic nature of a stroke data time series is used, and similarity may be determined by DP (Dynamic Programming) matching or Hidden Markov Model used in speech recognition.

In step S7, one or a plurality of prediction candidates (third strokes) are extracted. More specifically, stroke sets m+1, m+2, . . . , m+n as many as the pre-set number n of extraction candidates are extracted as prediction candidates in association with a set number m of second stokes similar to a stroke set of first strokes.

Note that in step S6, a plurality of stroke sets of second strokes similar to a stroke set of first strokes may be extracted. For example, when two similar stroke sets are extracted, stroke sets m1+1, m1+2, . . . , m1+n are extracted as a first prediction candidate group in association with a stroke number m1 of a second stroke, and stroke sets m2+1, m2+2, . . . , m2+n are extracted as a second prediction candidate group in association with a stroke number m2 of second strokes.

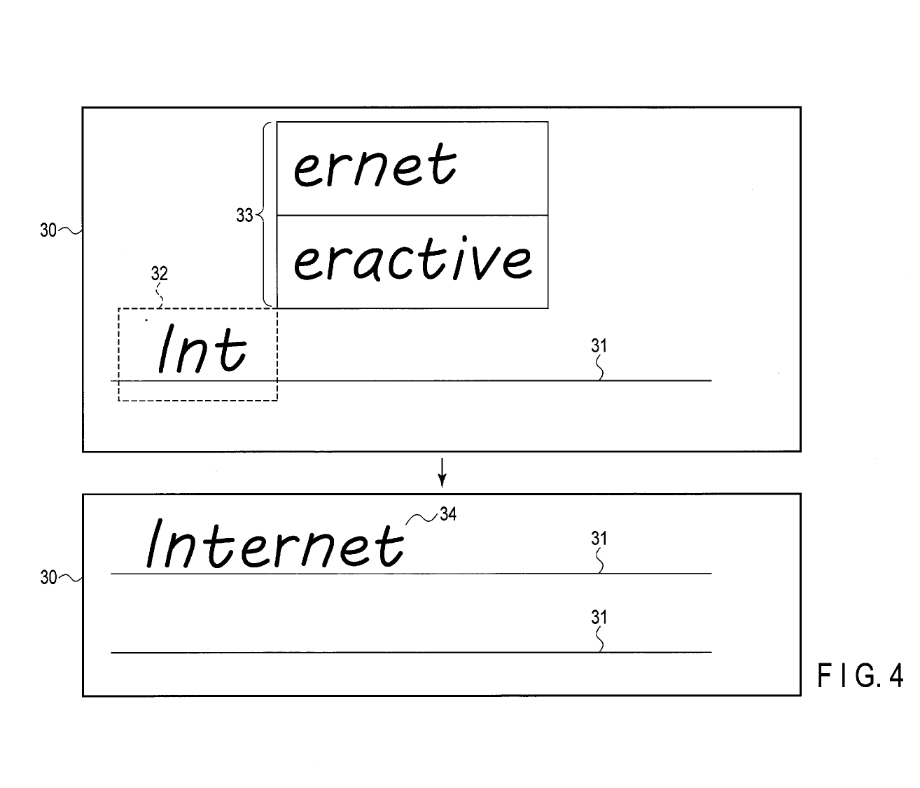

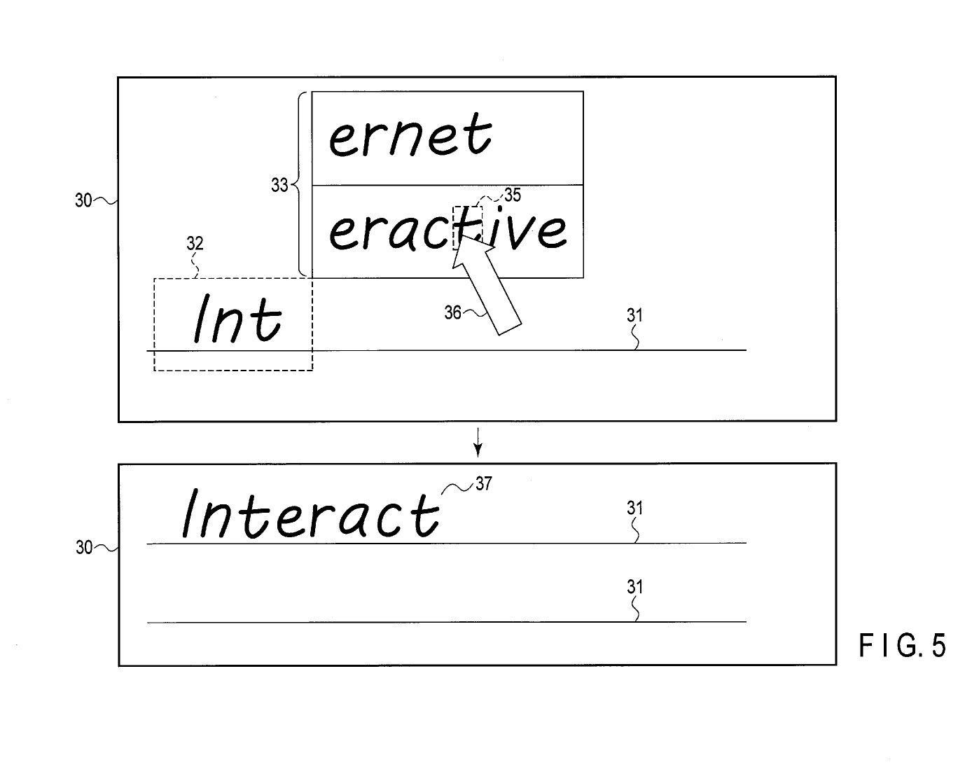

FIG. 4 shows a display example of an input prediction candidate list during handwriting input. FIG. 4 shows an input screen 30 of the notebook application displayed on the touch panel. FIG. 4 also shows row ruled lines 31 of a notebook which is being edited. The user can make a handwriting input via the pen input interface or the like. FIG. 4 shows a state in which the user has already input strokes 32 “Int” by handwriting. The strokes 32 are the aforementioned first strokes, and include three stroke sets corresponding to three characters in this example. In this case, for example, two prediction candidates 33, which are extracted according to this embodiment, are displayed. The first prediction candidate is “ernet”, and the next prediction candidate is “eractive”. When the user instructs, for example, the first prediction candidate “ernet”, the settled result display unit 8 settles this, and displays fourth strokes “ernet” together with “Int” as the first strokes during input. That is, an input of strokes 34 “Internet” is settled.

Especially, since this embodiment is configured to execute processing for units of stroke sets, the user can easily select and settle a predicted character (or character string) for a unit of a stroke set, as shown in FIG. 5. The example of FIG. 5 corresponds to a case in which the user clicks a stroke set 35 “t” by the pen. An arrow 36 represents a position clicked by the pen. With this click operation, fourth strokes “eract” are settled. These strokes include five stroke sets “e”, “r”, “a”, “c”, and “t”. As a result, an input of strokes 37 “Interact” is settled.

This embodiment includes a calculation unit which calculates a row structure of first strokes so as to display fourth strokes settled in prediction candidates on a row of the first strokes during input. The settled result display unit 8 displays the fourth strokes on the row of the first strokes based on the calculated row structure. Also, a list of prediction candidates 33 of strokes is displayed based on the row structure of the first strokes. That is, the prediction result display unit 5 displays third strokes as prediction candidates on rows parallel to that of the first strokes based on the calculated row structure of the first strokes.

The row structure of strokes can be calculated as follows. For example, from a coordinate set of stroke data included in a stroke set, a barycenter of that stroke set is calculated, thereby calculating a plurality of barycenters for a plurality of stroke sets. A row direction can be estimated from the plurality of barycenters by the least squares method. Note that a barycenter may be calculated for the predetermined number of stroke data in place of a stroke set.

Also, a row can be determined as a straight line which connects reference points in a plurality of stroke sets. More specifically, of a plurality of reference positions, that which is decided first is set as a start point, and a straight line which passes through reference points specified later or an approximate line which passes through positions as close to these reference point as possible is calculated. As the calculation method of an approximate line, a calculation method of a general linear function or n-ary function may be used based on coordinate information corresponding to reference positions.

The prediction candidates 33 extracted according to this embodiment may be displayed so that fingers of a hand of the user do not hide display contents according to a dominant hand of the user who makes a handwriting input. More specifically, an acquisition unit which acquires information required to specify the dominant hand of the user is arranged. The prediction result display unit 5 displays a list of prediction results (third strokes) at a position opposite to the dominant hand with reference to a position of first strokes. As for information of the dominant hand of the user, the user may set right or left handedness. Alternatively, the dominant hand may be automatically estimated based on a pen position and hand place position.

As described above, according to the first embodiment, the user can easily select and settle a prediction candidate by units of stroke sets, thus improving the operability of settlement selection of handwriting input prediction candidates.

More specifically, the need for a user operation for clipping a desired handwritten character string using a handle which moves in back-and-forth directions of a character string can be obviated, and the user can clip a character string by single clicking. For example, (1) the user can select a desired stroke set (clipping reference) by directly selecting a stroke, and (2) the user can indirectly select a desired stroke set (clipping reference) by selecting a circumscribed rectangle of each stroke set or a non-stroke portion inside that rectangle.

The storage unit 2 may store strokes while distinguishing handwriting input users, and strokes (including actually input strokes by handwriting and predicted strokes) of a first handwriting input user are allowed to be converted into those of a second handwriting input user, thus further advancing functions of the handwriting input user interface.

### Second Embodiment

In the second embodiment, the same reference numerals denote the same components as in the first embodiment, and a description thereof will not be repeated.

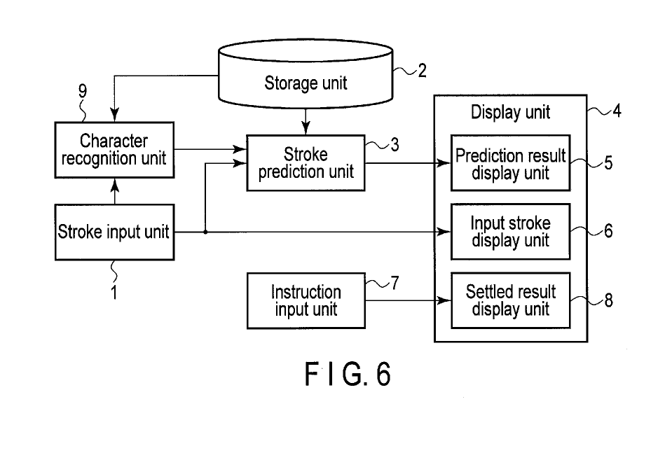

FIG. 6 is a block diagram showing a handwriting input support apparatus according to the second embodiment. In this apparatus, a character recognition unit 9 which executes character recognition of stroke sets is added to the arrangement of the first embodiment. In the second embodiment, a storage unit 2 stores characters or character strings which are retrieved using a character recognition result of the character recognition unit 9 as a search key. A stroke prediction unit 3 outputs retrieved characters or character strings as third strokes of prediction candidates.

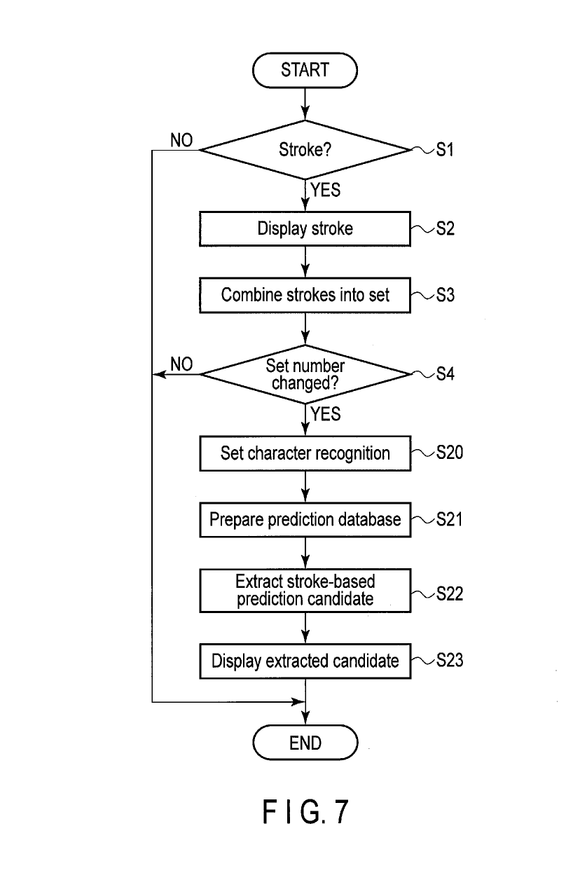

FIG. 7 is a flowchart showing an example of the handwriting input prediction processing according to the second embodiment. When the user inputs a stroke by operating a pen on a touch panel (step S1), that stroke is displayed on the touch panel by an input stroke display unit 6 (step S2). As described above, input strokes are combined into a set (step S3). Thus, a new set number is added, and prediction processing in steps S20 to S22 is executed via step S4. With this processing, prediction results are obtained based on character recognition results of stroke sets.

In step S20, the character recognition unit 9 executes character recognition of a stroke set.

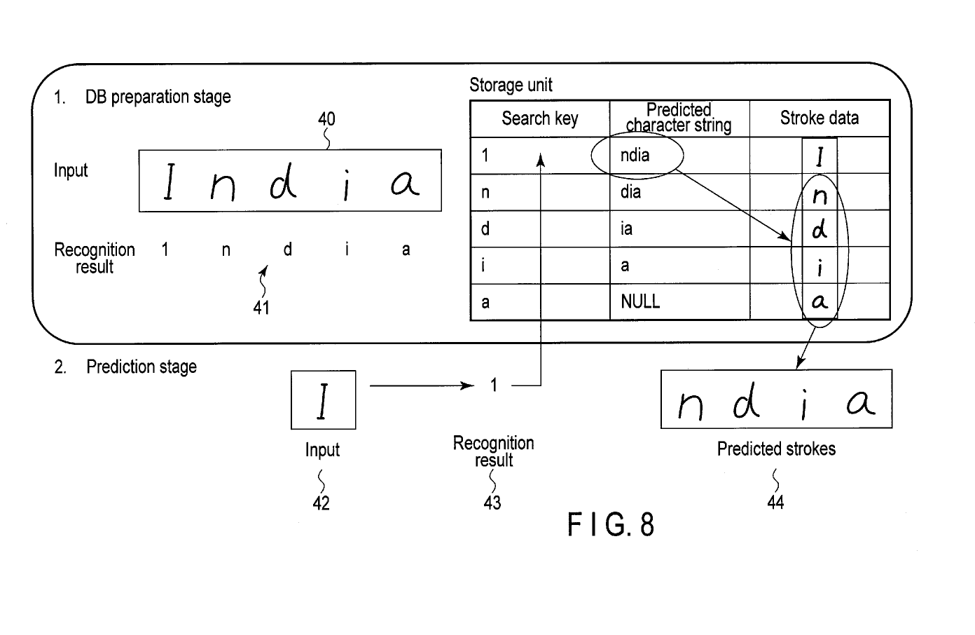

In step S21, a prediction database is prepared in the storage unit 2 based on character recognition. The preparation stage of this prediction database will be described below with reference to FIG. 8. Assume that first strokes 40 corresponding to “India” are input, as shown in FIG. 8. The first strokes 40 include five stroke sets corresponding to five characters. Assume that the character recognition unit 9 executes character recognition of the first strokes 40, and a recognition result “India” is obtained. A character string “ndia” which follows a recognized character “1” and stroke set data (a stroke of “I” and its stroke number) are registered in the prediction database. Thus, the character string “ndia” can be retrieved from the prediction database using the stroke number of “I” or its recognition result “1” as a search key. Likewise, a character string “dia” which follows a recognized character “n” and stroke set data (a stroke of “n” and its stroke number) are registered in the prediction database. Thus, the character string “dia” can be retrieved from the prediction database using the stroke number of “n” or its recognition result “n” as a search key. In this manner, all the recognition results of the input first strokes 40 are registered character by character. Data of strokes registered in the prediction database correspond to the aforementioned second strokes.

In step S22, stroke-based prediction candidate extraction is executed. This is a prediction stage shown in FIG. 8.

For example, strokes “India” have already been registered in the prediction database. In this case, assume that the user inputs a stroke 42 “I” by handwriting. This stroke 42 “I” undergoes character recognition, and a recognition result 43 “1” is obtained. In this case, the stroke prediction unit 3 searches the prediction database using the recognition result 43 “1” as a search key. As shown in FIG. 8, a predicted character string “ndia” is obtained from the prediction database. Data of strokes of respective characters of this predicted character string can be extracted from the prediction database. Therefore, strokes 44 (third strokes) of a prediction candidate “ndia” shown in FIG. 8 are obtained. Note that as in the first embodiment, stroke sets m+1, m+2, . . . , m+n as many as the pre-set number n of extraction candidates may be extracted as prediction candidates in association with a set number m of second strokes, a character recognition result of which matches that of first strokes. Alternatively, a plurality of set numbers of second strokes, character recognition results of which match that of first strokes, may be extracted.

In step S23, prediction candidates extracted based on character recognition are displayed.

According to the aforementioned second embodiment, prediction candidates are obtained based on character recognition, and the same effects as in the first embodiment can be provided.

### Third Embodiment

In the third embodiment, the same reference numerals denote the same components as those in the first and second embodiments, and a description thereof will not be repeated. The third embodiment obtains prediction candidates based on character recognition results of stroke sets as in the second embodiment. Also, the third embodiment uses a text-based word prediction technique when a likelihood of a character recognition result is high.

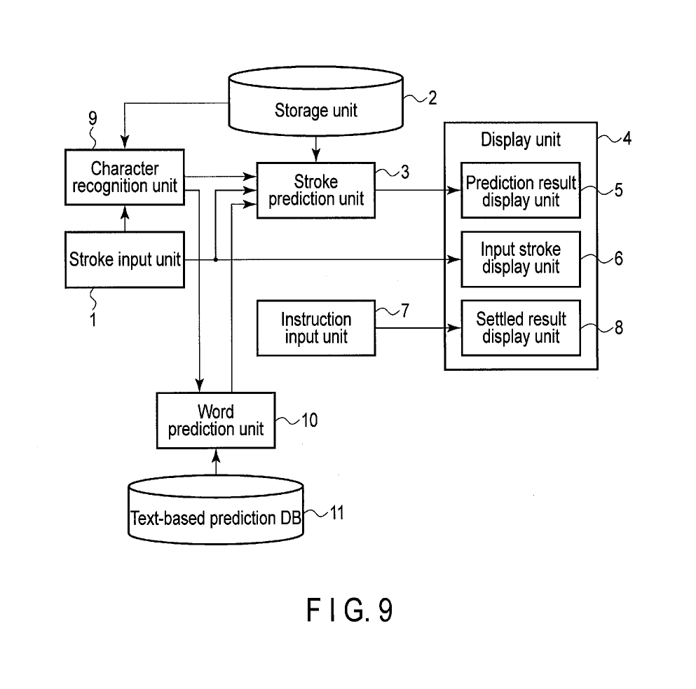

FIG. 9 is a block diagram showing a handwriting input support apparatus according to the third embodiment. In this apparatus, a word prediction unit 10 and text-based prediction database (DB) 11 are added to the arrangement of the second embodiment.

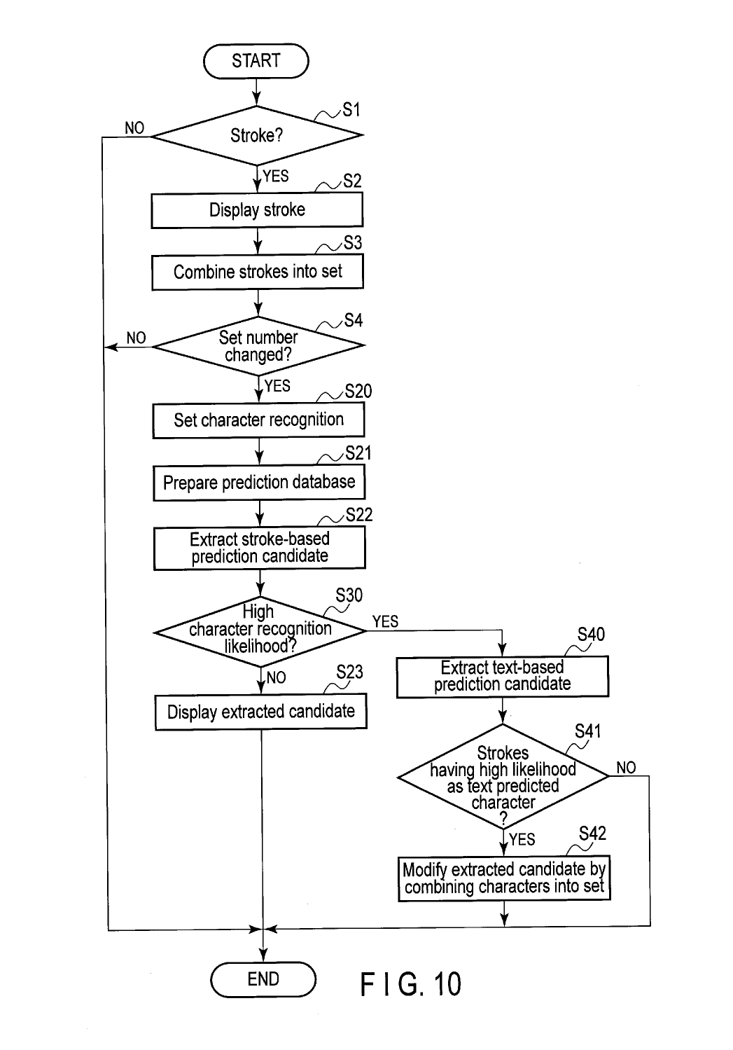

FIG. 10 is a flowchart showing an example of the handwriting input prediction processing according to the third embodiment. When the user inputs a stroke by operating a pen on a touch panel (step S1), that stroke is displayed on the touch panel by an input stroke display unit 6 (step S2). As described above, input strokes are combined into a set (step S3). Thus, a new set number is added, and prediction processing in steps S20 to S22 is executed via step S4. With this processing, prediction results (third strokes) are obtained based on character recognition results of stroke sets.

Assume that a predicted character string “ndia” is obtained from the prediction database, as shown in FIG. 8. When a likelihood as a result of character recognition of this predicted character string exceeds a first threshold (YES in step S30), the word prediction unit 10 searches the text-based prediction DE 11 for a word prediction corresponding to this predicted character string (step S40).

A stroke prediction unit 3 of this embodiment uses the word prediction obtained from the word prediction unit 10. In this case, text itself of the word prediction may be used as a final prediction candidate. Alternatively, strokes which have a likelihood exceeding a second threshold with respect to this word prediction may be used as third strokes of a prediction candidate (YES in step S41, step S42).

Alternatively, when there is no stroke corresponding to text (character string) of the word prediction, a font of the text of the word prediction may be converted into a handwritten font, and this font may be used as third strokes of a prediction candidate.

In step S23, prediction candidates extracted based on character recognition are displayed.

According to the aforementioned third embodiment, the same effects as in the first and second embodiments can be provided based on character recognition. Furthermore, according to the third embodiment, the precision of prediction candidates can be enhanced based on text-based word prediction.

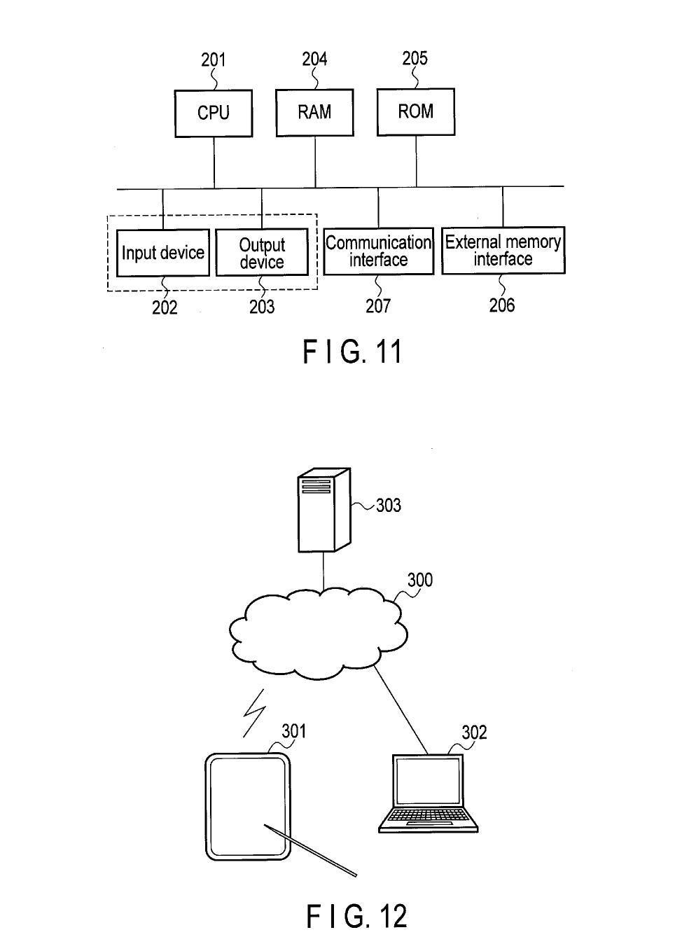

FIG. 11 is a block diagram showing an example of the hardware arrangement which implements the handwriting input support apparatus of the first to third embodiments. Referring to FIG. 11, reference numeral 201 denotes a CPU; 202, a predetermined input device; 203, a predetermined output device; 204, a RAM; 205, a ROM; 206, an external memory interface; and 207, a communication interface. For example, when a touch panel is used, for example, a liquid crystal panel, a pen, a stroke detection device arranged on the liquid crystal panel, and the like are used (see reference numeral 208 in FIG. 11).

For example, some components shown in FIGS. 1, 6, and 9 may be arranged on a client, and the remaining components shown in FIGS. 1, 6, and 9 may be arranged on a server.

For example, FIG. 12 exemplifies a state in which a handwriting input support apparatus of this embodiment is implemented when a server 303 is connected on a network 300 such as an intranet and/or the Internet, and clients 301 and 302 communicate with the server 303 via the network 300.

Note that in this example, the client 301 is connected to the network 300 via wireless communications, and the client 302 is connected to the network 300 via wired communications.

The clients 301 and 302 are normally user apparatuses. The server 303 may be arranged on, for example, a LAN such as an intra-firm LAN, or may be managed by, for example, an Internet service provider. Alternatively, the server 303 may be a user apparatus, so that a certain user provides functions to other users.

Various methods of distributing the components in FIGS. 1, 6, and 9 to the clients and server are available.

Instructions of the processing sequence described in the aforementioned embodiments can be executed based on a program as software. A general-purpose computer system pre-stores this program, and loads the program, thereby obtaining the same effects as those of the handwriting input support apparatus of the aforementioned embodiments. Instructions described in the aforementioned embodiments are recorded in a recording medium such as a magnetic disk (flexible disk, hard disk, etc.), optical disk (CD-ROM, CD-R, CD-RW, DVD-ROM, DVD±R, DVD±RW, etc.), a semiconductor memory, and the like as a program that can be executed by a computer. The storage format of such recording medium is not particularly limited as long as the recording medium is readable by a computer or embedded system. The computer loads the program from this recording medium, and controls a CPU to execute instructions described in the program based on the program, thereby implementing the same operations as the handwriting input support apparatus of the aforementioned embodiments. Of course, the computer may acquire or load the program via a network.

Also, an OS (Operating System), MW (middleware) such as database management software or network, which run on a computer may execute some of the processes required to implement this embodiment based on instructions of the program installed from the recording medium into the computer or embedded system.

Furthermore, the recording medium of this embodiment is not limited to a medium independent of the computer or embedded system, and includes a recording medium which stores or temporarily stores a program downloaded via a LAN or Internet.

The number of recording media is not limited to one, and the recording medium of this embodiment includes a case in which the processes of this embodiment are executed from a plurality of media. Hence, the configuration of the medium may be an arbitrary configuration.

Note that the computer or embedded system of this embodiment is required to execute respective processes of this embodiment, and may adopt any of arrangements such as a single apparatus such as a personal computer or microcomputer or a system in which a plurality of apparatuses are connected via a network.

The computer of this embodiment is not limited to a personal computer, and includes an arithmetic processing device, microcomputer and the like included in an information processing apparatus, and collectively means a device and apparatus which can implement the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A handwriting input support apparatus comprising:
a stroke input unit that inputs first strokes, one stroke set of which corresponds to one character or one symbol;
a stroke storage unit that stores second strokes, the one stroke set of which corresponds to the one character or one symbol;
a stroke prediction unit that predicts third strokes, the one stroke set of which corresponds to the one character or one symbol, by searching for the second strokes using the first strokes;
a prediction result display unit that displays the third strokes; and
a settled result display unit that settles fourth strokes by an instruction given to the stroke set of the third stroke, and displays the fourth strokes together with the first strokes.

2. The apparatus of claim 1, further comprising a calculation unit that calculates a row structure of the first strokes,
wherein the settled result display unit displays the fourth strokes on a row of the first strokes based on the row structure.

3. The apparatus of claim 1, further comprising a calculation unit that calculates a row structure of the first strokes,
wherein the prediction result display unit displays the third strokes on a row parallel to a row of the first strokes based on the row structure.

4. The apparatus of claim 1, further comprising an acquisition unit that acquires information required to specify a dominant hand of a user,
wherein the prediction result display unit displays the third strokes at a position opposite to the dominant hand with reference to a position of the first strokes.

5. The apparatus of claim 1, further comprising a character recognition unit that executes character recognition of the stroke set,
wherein the storage unit stores a character string to be retrieved using the character recognition result as a search key, and
the stroke prediction unit outputs strokes corresponding to the character string as the third strokes.

6. The apparatus of claim 5, further comprising a text-based word prediction unit that gives, when a character recognition result of the third strokes has a likelihood exceeding a first threshold, a word prediction to the character recognition result,
wherein the stroke prediction unit obtains the third strokes using the work prediction.

7. The apparatus of claim 6, wherein the stroke prediction unit obtains strokes having a likelihood exceeding a second threshold with respect to the word prediction as the third strokes or a character string of handwritten fonts corresponding to the word prediction as the third strokes.

8. A computer-readable recording medium that stores a program for controlling a computer to function as:
a stroke input unit that inputs first strokes, one stroke set of which corresponds to one character or one symbol;
a stroke storage unit that stores second strokes, the one stroke set of which corresponds to the one character or one symbol;
a stroke prediction unit that predicts third strokes, the one stroke set of which corresponds to the one character or one symbol, by searching for the second strokes using the first strokes;
a prediction result display unit that displays the third strokes; and
a settled result display unit that settles fourth strokes by an instruction given to the stroke set of the third stroke, and displays the fourth strokes together with the first strokes.

9. A handwriting input support apparatus comprising:
a processor configured to input first strokes, one stroke set of which corresponds to one character or one symbol, to predict third strokes, the one stroke set of which corresponds to the one character or one symbol, by searching for second strokes, the one stroke set of which corresponds to the one character or one symbol, using the first strokes, to display the third strokes, to settling fourth strokes by an instruction given to the stroke set of the third stroke, and to display the fourth strokes together with the first strokes; and
a memory connected to the processor.
